(19) United States
(12) Patent Application Publication
(10) Pub. No.: US 2013/0138722 A1
(43) Pub. Date: May 30, 2013

(54) INFORMATION PROCESSING APPARATUSES SYSTEM SUITABLE TO IMPLEMENT AND MODIFY A HIGH DENSITY COMPUTATIONAL BUSINESS LOGIC PROGRAM ONLY ACTING ON THE HIGH DENSITY COMPUTATIONAL BUSINESS LOGIC PROGRAM PLACED IN THE DATABASE SERVER COMPUTER

(71) Applicants: Riccardo Angelo Enrico Bella, Milano (IT); Barbara Maria Bozzi, Milano (IT); Andrea Conti, Milano (IT); Stefano Galleni, Milano (IT); Francesco Giovanni Gelfi, Milano (IT); Danilo Francesco Nervo, Lainate (IT); Andrea Luigi Innocente Villa Luraschi, Milano (IT)

(72) Inventors: Riccardo Angelo Enrico Bella, Milano (IT); Barbara Maria Bozzi, Milano (IT); Andrea Conti, Milano (IT); Stefano Galleni, Milano (IT); Francesco Giovanni Gelfi, Milano (IT); Danilo Francesco Nervo, Lainate (IT); Andrea Luigi Innocente Villa Luraschi, Milano (IT)

(21) Appl. No.: 13/307,999

(22) Filed: Nov. 30, 2011

(51) Int. Cl. G06F 15/16

(52) U.S. Cl. 709/203

(57) ABSTRACT

An information processing apparatuses system including one or more servers and one or more terminal devices connected via web. The system is suitable to implement and modify a high density computational business logic program only acting on said high density computational business logic program placed in the database server. The system includes a database computer server, an application computer server, an http computer server, web application and graphical user interface on the terminal device.

### FIELD

The present invention relates to an information processing apparatuses system suitable to implement and modify a high density computational business logic program compatible with the financial field computer security standard only acting on the high density computational business logic program placed in the database server computer, avoiding the installing of a new business logic program on the terminal devices in case of significant changes of said high density computational business logic program.

### BACKGROUND OF THE INVENTION

Many business fields are organized to perform various office procedures remotely. Business Logic Programs that are used in these procedures can be very simple, such as the compilation and submission of orders for the supply of material. These programs are used by computer systems which usually have a structure consisting of a server computer and one or more terminal device suitable to connect to the server computer to allow operators to perform various office procedures

However, there are business fields where this type of program has to process a large number of data and cross a considerable amount of information. Said program is usually name “high-density computational business logic program.”

This type of program is often used in business areas where the security of the data and the security of the information are very important, such as the financial sector. The high-density computational business logic program must be compatible with technology computer security accepted by the financial sector. The high-density computational business logic program compatible with the technology of computer security will be accepted by the financial sector are hereinafter called “Secure HD Program”.

It is known that there are countless problems that must be addressed in relation to Secure Program and we have more problems in case said program is used via the web. In this case the additional problems concern both the security protocols than the management of the data flowing via the web. As mentioned above, the Secure HD program is used for the treatment and processing of a considerable number of data and information according to a high security standard.

To manage and develop a considerable amount of data and information transmitted via the web, maintaining a security accepted in the financial sector, hereinafter referred to as “Secure Information Processing System”, the state of the art teaches to have a Secure Information Processing System consisting in one or more computer servers which are complex and expensive and one or more terminal devices used by operators to perform various procedures which are also complex to manage.

The complexity and high cost of the Secure Information Processing System known have highlighted several problems.

The applicants have examined particularly the Secure Information Processing System of the financial sector relating to finance leases and with the present invention solve the problems identified for that specific sector. The present invention is obviously applicable and claimed in the claims below to other areas in which there are similar problems

THE PROBLEMS TO BE SOLVED

In most of the financial institutions, the Secure Information Processing System for the formation and management of finance leasing agreement, in short hereinafter “Leasing Secure Information Processing System” usually involves the adoption of an IBM AS/400 server computer of the type or similar.

Those type of computer servers, technologies and programs correspond precisely to the needs of reliability and performance required by the field of processing and management of finance leasing agreements.

The Leasing Secure Information Processing System known includes: (i) a server computer IBM AS/400 or similar type which have stored a set of data and information, the so-called database and at least: (a) a Secure HD Program to process and manage of data and information in the database, in short “Central Secure HD Program”; (b) a software for web communication, (ii) one or more terminal devices for the operators on which appropriate software is installed to communicate with the Central HD Secure Program, called in short “Client Secure HD Program. The Leasing Secure Information Processing System known have the following problems: (1) it “runs” only on IBM AS/400 or similar type of server computer; (2) it does not allow to modify the Client Secure HD Program via the web, requiring the installing of said program on each terminal device.

Financial institutions have recently begun to streamline their computer systems, standardizing the technologies used for computer systems: as mentioned above, IBM AS/400 computer was used almost exclusively by financial institutions for the financial leasing sector, using for the other financial sectors less expensive and more handy server computer.

The recent problems in the financial sector has also highlighted the need to update more quickly the close-assessment criteria and the economic conditions to be applied for the conclusion of a finance leasing agreement.

The necessity of having to manually change the Client Secure HD Program described above it is certainly a very important disadvantage: we have to considered that we can have the risk that an operator cannot enter into a leasing agreement because the Client Secure HD Program on his terminal device is no longer compatible with the running version of the Central Secure HD Program, this operator being on hold, for example, waiting for the maintenance service that has to install the new Client HD Secure Program on the his/her computer manually.

### SUMMARY OF THE INVENTION

The problems mentioned in the previous paragraph are solved by an information processing apparatuses system operating via web suitable to implement and modify a high density computational business logic program compatible with the financial field computer security standard only acting on said high density computational business logic program placed in the database server computer structuring the information processing apparatuses system with a database server computer, an application server computer, an http server computer, a web application and a graphical user interface on the terminal device.

It is preferred that high density computational business logic program is programmed in PL/SQL language and on board of the database server computer is a Presentation Manager Middleware with an AJAX manager program. An AJAX manager program is also on the terminal device which has also a graphic user interface. The terminal device has no high density computational business logic program which is on the database server computer only.

The system is completed with the application server computer and the http server computer with a simple object access protocol interface and preferably the http server computer has a servlet interpreter JSP and AJAX manager program.

This system of the present invention permits to have the terminal device with no business logic program on board. The peculiar aspect of the terminal device of this system is to have, together to a graphical user interface, an AJAX manager program, the same type of program comprises in the Presentation Manager Middleware program on board of the database server computer.

The system above explained and in particular an AJAX manager program on terminal device as well a the AJAX manager program on the Presentation Manager Middleware program on the database server computer is new. In particular said system is against the proper information technology procedures. However the system has worked surprisingly.

Such system permits to use inexpensive commercial computer servers and to avoid to have the business logic program on the terminal device, solving the technical problems of the known information processing system.

### BRIEF DESCRIPTION OF THE DRAWINGS

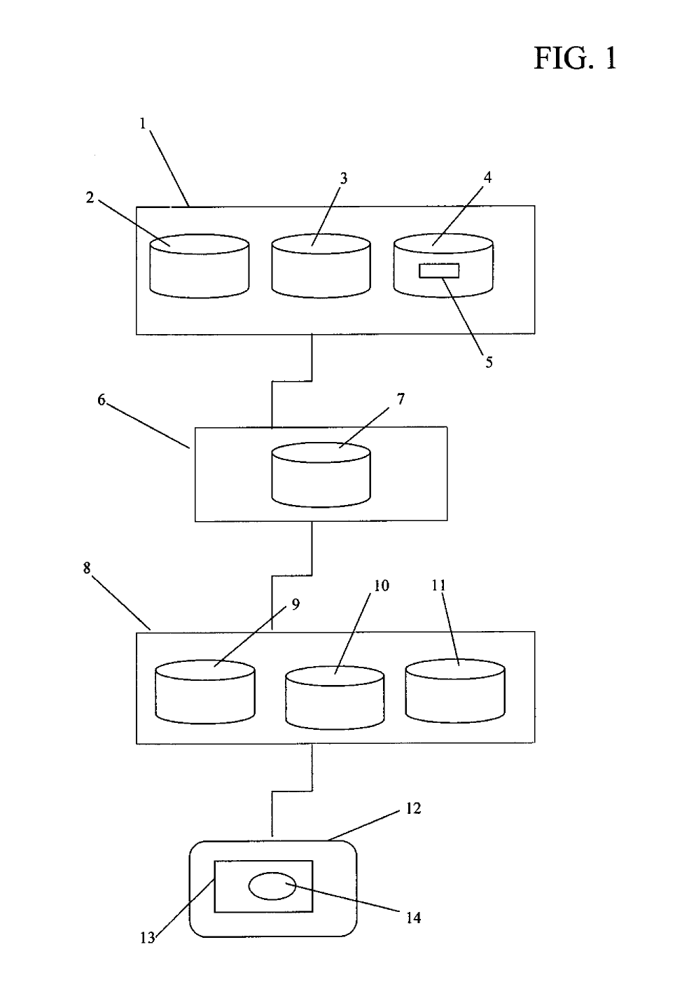

The FIG. 1 shows the information processing apparatus system under reference operating via web in which the data base server computer (1) having the data and the information (2) to be processed by the high density computational business logic program (3) compatible with the financial field computer security standard programmed in PL/SQL language and a Presentation Manager Middleware (4) equipped with an Ajax Manager program. Said data base server computer (1) is connected to an application server computer (6) having a simple object access protocol interface (7) being said application computer (6) linked to an http server computer (8) having a having a simple object access protocol interface (9), an interpreter JSP and an AJAX manager program.

The information processing apparatus system under reference ends with a terminal device (12) like a lap top, for example, having a graphical user interface (13) comprising a Ajax manager program interface (14)

With the above invention has been described in conjunction with specific financial field thereof, it is evident that some alternatives, modifications and variation will be apparent to those skilled in the art. Accordingly, the performed embodiment of the invention as set for herein, an intended to be illustrative, without departing from the true spirit and full scope of the invention as set forth herein and defined in the claims.

What is claimed is:

1. An information processing apparatuses system operating via web suitable to implement and modify a high density computational business logic program compatible with the financial field computer security standard only acting on said high density computational business logic program placed in the database server computer, wherein the system comprises:
a database server computer; an application server computer; an http server computer; and
a web application and a graphical user interface on the terminal device.

2. An information processing apparatuses system according to claim 1, wherein the graphical users interface on the terminal device comprises an AJAX manager program front-ware.

3. An information processing apparatuses system according to claim 1, wherein the database server computer comprises a business logic programmed in PL/SQL language and a Presentation Manager Middleware.

4. An information processing apparatuses system according to claim 3, wherein said Presentation Manager Middleware comprises a AJAX manager program.

5. An information processing apparatuses system according to claim 1, wherein the application server computer and the http server computer comprise a simple object access protocol interface.

6. An information processing apparatuses system according to claim 5, wherein the http server computer comprises a servlet interpreter JSP and AJAX manager program.
